SEQUENCE LISTING (6 sequences)

SEQ ID NO: 1 - DNA, 34 bp, Artificial Sequence
  synthetic olgionucleotide
nnnnnnnnnncgannnnnntgcnnnnnnnnnnnn

SEQ ID NO: 2 - DNA, 34 bp, Artificial Sequence
  synthetic olgionucleotide
nnnnnnnnnngcannnnnntcgnnnnnnnnnnnn

SEQ ID NO: 3 - DNA, 34 bp, homo sapiens
gctgtgcgcccgagggcactgctggggtccaggg

SEQ ID NO: 4 - DNA, 34 bp, homo sapiens
ctggaccccagcagtgccctcgggcgcacagctg

SEQ ID NO: 5 - DNA, 35 bp, Artificial Sequence
  synthetic olgionucleotide
gctgtgcgcccgagggcactgctggggtccagggc

SEQ ID NO: 6 - DNA, 55 bp, Artificial Sequence
  synthetic olgionucleotide
gcgcgcgcttttgcgcgcgcgccctggaccccagcagtgccctcgggcgcacagc

(19) United States
(12) Patent Application Publication
(10) Pub. No.: US 2009/0181853 A1
(43) Pub. Date: Jul. 16, 2009

(54) ARRAY-BASED METHOD FOR PERFORMING GENOMIC ANALYSIS

(76) Inventor: Brian J. Peter, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/013,380

(22) Filed: Jan. 11, 2008

(51) Int. Cl. C40B 30/04; C40B 40/08

(52) U.S. Cl. 506/9; 506/17

(57) ABSTRACT

An array-based method for performing genomic analysis is provided. In certain embodiments, the method may comprise: a) contacting a sample comprising genomic DNA with a Type IIB restriction enzyme to produce Type IIB fragments; b) directly labeling the Type IIB fragments with a fluorescent label to produce labeled fragments; c) contacting the labeled fragments with an array to produce a contacted array; and d) reading the contacted array to produce data. In certain instances, the data may be analyzed to determine the copy number of a genomic region in the sample. Also provided are arrays and kits useful to practice the method.

### BACKGROUND

Malignant tumors (cancers) are the second leading cause of death in the United States, after heart disease (Boring et al., CA Cancer J. Clin. 1993; 43:7-26). Cancer has been associated with copy number variations in regions of the genome; either deletions of a part of the genome, resulting in loss of a tumor suppressor, or with amplification of part of the genome, resulting in gene overexpression (Futreal et al., Nat. Rev. Cancer 2004; 4:177-183). Copy number variation has also been strongly associated with specific diseases such as Parkinson's, Alzheimer's, Prader-Willi, Charcot-Marie-tooth and CHARGE syndrome (Redon et al., Nature 2006; 444: 444-454; Freeman et al., Genome Res. 2006; 16:949-961).

In addition to the genetic variation demonstrated by studies of single nucleotide polymorphisms in the human population, there is significant genetic variation in the form of variation in the copy number of genomic regions (Redon et al., supra; Freeman et al., supra). Using a microarray approach and looking for variations in copy number of regions larger than 1 kilobase (kb) Redon et al., found a total of 1,447 discrete variations in copy number, amounting to 12% of the genome or about 360 megabases (Mb). Using a paired-end sequencing approach, investigators identified 241 variations in copy number in the human genome, with most in the size range of 8 kb to 40 kb (Tuzun et al., Nat. Genet. 2005; 37:727-732). These studies show the human genome may have widespread copy number variation, and developing technologies facilitating the analysis of copy number variation is a priority for future analysis.

Methods and compositions for genome analysis are described herein.

### SUMMARY

An array-based method for performing genomic analysis is provided. In certain embodiments, the method may comprise: a) contacting a sample comprising genomic DNA with a Type IIB restriction enzyme to produce Type IIB fragments; b) directly labeling the Type IIB fragments with a fluorescent label to produce labeled fragments; c) contacting the labeled fragments with an array to produce a contacted array; and d) reading the contacted array to produce data. In certain instances, the data may be analyzed to determine the copy number of a genomic region in the sample. Also provided are arrays and kits useful to practice the method.

### BRIEF DESCRIPTION OF THE FIGURES

FIG. 1 schematically illustrates one embodiment of the subject method.

FIGS. 2A-2C schematically illustrate other embodiments of the subject method.

### DEFINITIONS

The term “nucleic acid” and “polynucleotide” are used interchangeably herein to describe a polymer of any length, e.g., greater than about 10 bases, greater than about 100 bases, greater than about 500 bases, greater than 1000 bases, usually up to about 10,000 or more bases composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions. Naturally-occurring nucleotides include guanine, cytosine, adenine and thymine (G, C, A and T, respectively).

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes a single stranded multimer of nucleotide of from about 10 to 200 nucleotides. Oligonucleotides are usually synthetic and, in many embodiments, are fewer than 80 nucleotides in length. Oligonucleotides may contain ribonucleotide monomers (i.e., may be oligoribonucleotides) or deoxyribonucleotide monomers. Oligonucleotides may be 10 to 20, 11 to 30, 31 to 40, 41 to 50, 51 to 60, 61 to 70, 71 to 80, 80 to 100, 100 to 150 or 150 to 200 nucleotides in length, for example.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other nucleic acids that are C-glycosides of a purine or pyrimidine base, polypeptides (proteins), polysaccharides (starches, or polysugars), and other chemical entities that contain repeating units of like chemical structure.

A primer that is made of “naturally occurring” nucleotides is a primer that is made up of naturally-occurring adenine (A), thymine (T), guanine (G), and cytosine (C) residues. The term “sample” as used herein relates to a material or mixture of materials, typically, although not necessarily, in liquid form, containing one or more components of interest.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “surface-tethered oligonucleotide” refers to a nucleic acid that is immobilized on a surface of a solid substrate, where the substrate can have a variety of configurations, e.g., a sheet, bead, or other structure. In certain embodiments, the oligonucleotide probes employed herein are present on a surface of the same planar support, e.g., in the form of an array.

An “array” includes any two-dimensional or substantially two-dimensional (as well as a three-dimensional) arrangement of spatially addressable regions bearing nucleic acids, particularly oligonucleotides or synthetic mimetics thereof, and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a surface of the substrate. Depending upon the use, any or all of the arrays may be the same or different from one another and each may contain multiple spots or features. An array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μm², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 mm and less than 1.5 mm, such as more than about 0.8 mm and less than about 1.2 mm.

Arrays can be fabricated using drop deposition from pulse-jets of either precursor units (such as nucleotide or amino acid monomers) in the case of in situ fabrication, or a previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents. An array is “addressable” when it has multiple regions of different moieties (e.g., different oligonucleotide sequences) such that a region (i.e., a “feature” or “spot” of the array) at a particular predetermined location (i.e., an “address”) on the array contains a particular sequence. Array features are typically, but need not be, separated by intervening spaces.

The term “mixture” as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not spatially distinct. In other words, a mixture is not addressable. To be specific, an array of surface-bound oligonucleotides, as described below, is not a mixture of surface-bound oligonucleotides because the species of surface-bound oligonucleotides are spatially distinct and the array is addressable.

“Isolated” or “purified” generally refers to isolation of a substance (compound, polynucleotide, protein, polypeptide, polypeptide composition) such that the substance comprises a significant percent (e.g., greater than 1%, greater than 2%, greater than 5%, greater than 10%, greater than 20%, greater than 50%, or more, usually up to about 90%-100%) of the sample in which it resides. In certain embodiments, a substantially purified component comprises at least 50%, 80%-85%, or 90-95% of the sample. Techniques for purifying polynucleotides and polypeptides of interest are well-known in the art and include, for example, ion-exchange chromatography, affinity chromatography and sedimentation according to density. Generally, a substance is purified when it exists in a sample in an amount, relative to other components of the sample that is not found naturally.

The term “size separating” refers to the partition of a mixture of DNA fragments according to molecular weight. Techniques for size separating polynucleotides and polypeptides of interest are well known in the art and include, but are not limited to, such techniques as gel purification and column chromatography.

The terms “determining”, “measuring”, “evaluating”, “assessing” and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The term “using” has its conventional meaning, and, as such, means employing, e.g., putting into service, a method or composition to attain an end.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. The term stringent assay conditions refer to the combination of hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions determines whether a nucleic acid is specifically hybridized to a probe. Wash conditions used to identify nucleic acids may include, e.g.: a salt concentration of about 0.02 M NaCl at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or equivalent conditions. Stringent conditions for washing can also be, e.g., 0.2×SSC/0.1% SDS at 42° C. In instances wherein the nucleic acid molecules are oligonucleotides, stringent conditions can include washing in 6×SSC/0.05% sodium pyrophosphate at 37° C. (for 14-base oligonucleotides), 48° C. (for 17-base oligonucleotides), 55° C. (for 20-base oligonucleotides), and 60° C. (for 23-base oligonucleotides). (See Sambrook et al., Molecular Cloning: A Laboratory Manual, Third Edition, 2001 Cold Spring Harbor, N.Y., for detailed descriptions of equivalent hybridization and wash conditions and for reagents and buffers, e.g., SSC buffers and equivalent reagents and conditions.)

A specific example of stringent assay conditions is rotating hybridization at 65° C. in a salt based hybridization buffer with a total monovalent cation concentration of 1.5M (e.g., as described in U.S. patent application Ser. No. 09/655,482 filed on Sep. 5, 2000 the disclosure of which is herein incorporated by reference) followed by washes of 0.5×SSC and 0.1×SSC at room temperature.

Stringent hybridization conditions may also include a “prehybridization” of aqueous phase nucleic acids with complexity-reducing nucleic acids to suppress repetitive sequences and reduce the complexity of the sample prior to hybridization. For example, certain stringent hybridization conditions include, prior to any hybridization to surface-bound oligonucleotides, hybridization with Cot-1 DNA, or the like.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

As used herein, the term “genomic sample” refers to refers to a sample that contains genomic DNA from a cell. A genomic sample may contain genomic DNA fragmented by an enzyme or by sonication, for example. A genomic sample may contain amplified or unamplified genomic DNA.

The terms “restriction enzyme” and “restriction endonuclease” are synonymous and refer to a nuclease which recognizes a specific sequence of nucleotides in double stranded DNA and enzymatically cleaves the DNA at or near the specific sequence. A “restriction enzyme site” refers to the specific sequence of nucleotides recognized by the restriction enzyme.

The term “Type IIB restriction enzyme” refers to a restriction enzyme that recognizes a restriction enzyme site and cleaves twice; one on either side of the site, leaving the restriction site intact and releasing the restriction site on a short DNA fragment. Such enzymes are described by Marshall et al., (J. Mol. Biol. 2007; 367:419-431). Exemplary Type IIB enzymes include: AloI, PpiI, PsrI, BplI, FalI, Bsp24I, BsaXI, HaeIV, CjeI, CjePI, Hin4I, BaeI, AlfI, BcgI and BslFI.

The terms “Type IIB fragment,” or “Type IIB restriction enzyme fragment” and “Type IIB restriction fragment” are synonymous and refer to a DNA fragment obtained by digestion of a nucleic acid with a Type IIB restriction enzyme. A Type IIB fragment has a length that is defined by the Type IIB restriction enzyme used for digestion. Digestion of genomic DNA with a Type IIB restriction enzyme results in: a) Type IIB fragments, i.e., a population of DNA fragments of a discrete length determined by the Type II restriction enzyme used, and b) the remainder of the genomic DNA, where the remainder of the genomic DNA lies between the Type IIB fragments. In certain cases, the Type IIB fragments may be concatenated, or otherwise contiguously linked together.

As used herein, the term “directly labeling” refers to a detectably labeling a nucleic acid without any prior covalent modification or amplification of the nucleic acid. For example, if Type IIB fragments are detectably labeled after digestion and/or separation, the Type IIB fragments are not amplified or covalently modified prior to labeling. Such fragments may be further purified or stored for a period of time prior to being directly labeled. Directly labeling includes attachment of a single label or multiple labels

The term “copy number” as used herein, refers to the number of copies of a particular region in the genomic DNA of a sample, e.g., a biopsy or sample of cultured cells.

If a genomic region has an “abnormal copy number,” the genomic region has a copy number that is significantly different to that of the average copy number of the remainder of the genome. Absolute copy number refers to a copy number that can be obtained without comparison to a reference sample.

If a set of oligonucleotides “corresponds to” or is “for” a certain Type IIB fragment, the oligonucleotides base pair with, i.e., specifically hybridizes to, that genomic region that contains that Type IIB fragment. A “Type IIB fragment-detecting oligonucleotide” as used herein, refers to an oligonucleotide of a specific sequence that is complementary to, and hybridizes with, a Type IIB fragment of the genome. As will be discussed in greater detail below, a set of oligonucleotides for a particular Type IIB fragment and the genomic regions that contains that Type IIB fragment, or complement thereof, contain at least one region of contiguous nucleotides that is identical in sequence and allows the oligonucleotides to hybridize to the Type IIB fragment.

As used herein, the terms “equilibrium” and “binding equilibrium” with respect to hybridization conditions refers to a state in which: a) the rate of binding between two nucleic acids to form a nucleic acid duplex; and, b) the rate of separation of the two nucleic acids of the duplex, are equal.

As used herein, the term “nucleic acid duplex” refers to the duplex formed by hybridization of two nucleic acids.

As used herein, the term “Tₘ” refers to the melting temperature of a nucleic acid duplex under the hybridization conditions used.

As used herein, the term “destabilization element” refers to an element in the nucleotide sequence of an oligonucleotide that decreases the stability of a duplex containing: a) an oligonucleotide and b) a matched Type IIB fragment that specifically binds to the oligonucleotide. Nucleotide insertions, substitutions, mismatches and non-naturally occurring nucleotides are types of destabilizing elements. Exemplary destabilizing elements are described in published U.S. Patent Application No. 2007008730.

As used herein, the term “duplex destabilizing agent” refers to a compound that, when added to a hybridization reaction between to complementary nucleic acids, destabilizes the duplex formed between the nucleic acids. Duplex destabilizing agents effectively lower the Tₘ of a nucleic acid duplex.

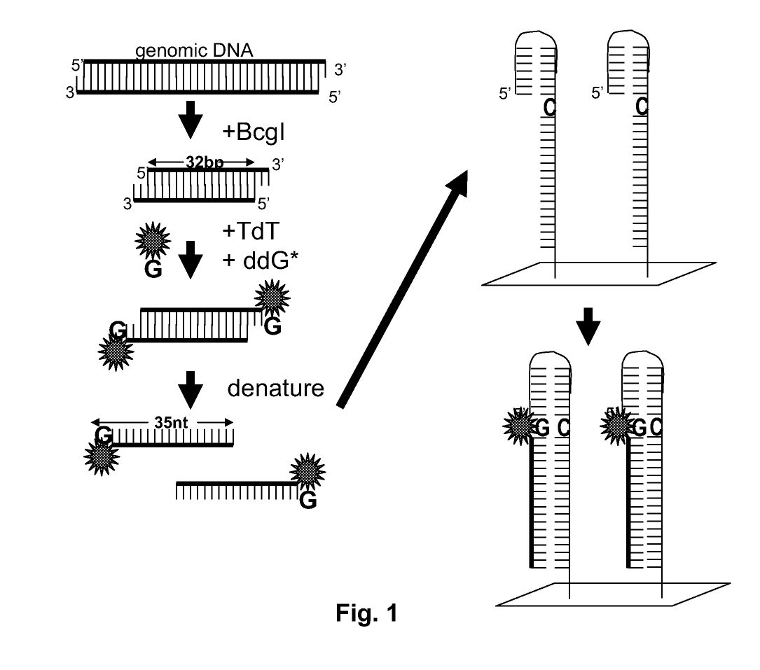

As used herein, the term “hairpin” refers to a nucleic acid structure with a loop of at least 3 or 4 nucleotides and a double-stranded stem in which complementary nucleotides bind to each other in an anti-parallel manner. The hairpin structure may contain from approximately 5 to about 30 nucleotides, e.g., about 8-20 nucleotides. The double stranded stem may be 5-20 nucleotides, e.g. 6-10 nucleotides, in length. The terminal nucleotide of the hairpin, i.e., the nucleotide at the end of an oligonucleotide that is distal to the end that is tethered to a solid support, is present in the double stranded region of the hairpin. In a duplex formed between an oligonucleotide probe containing a hairpin region and a Type IIB fragment, the hairpin region may in certain cases, promote a phenomenon termed “stacking” which allows the Type IIB fragment to bind more tightly, i.e., more stably. When a labeled Type IIB fragment is bound to an oligonucleotide probe containing a hairpin region, a terminal nucleotide of the labeled Type IIB fragment may occupy a position that is immediately adjacent to a terminal nucleotide of the oligonucleotide probe (as shown in FIG. 1). In effect, in this embodiment, the duplex produced by binding of a labeled Type IIB fragment to an oligonucleotide probe resembles a long hairpin structure containing a nick in the stem of the hairpin. Stacking and its effect on duplex stability are discussed in Liu et al (Nanobiology 1999; 4: 257-262), Walter et al (Proc. Natl. Acad. Sci. 1994; 91:9218-9222) and Schneider et al (J. Biomol. Struct. Dyn. 2000; 18:345-52).

The term “single nucleotide extended Type IIB fragment” refers to a nucleic acid composed of a Type IIB fragment and a single nucleotide added to the end of the Type IIB fragment. The single nucleotide may be added to the end of the Type IIB fragment chemically, or by extending the Type IIB fragment using an enzyme, e.g., a terminal deoxytransferase. The single nucleotide added to a Type IIB fragment to make a single nucleotide extended Type IIB fragment is referred to herein as the “extended nucleotide.”

### DESCRIPTION OF EXEMPLARY EMBODIMENTS

An array-based method for performing genomic analysis is provided. In certain embodiments, the method may comprise: a) contacting a sample comprising genomic DNA with a Type IIB restriction enzyme to produce Type IIB fragments; b) directly labeling the Type IIB fragments with a fluorescent label to produce labeled fragments; c) contacting the labeled fragments with an array to produce a contacted array; and d) reading the contacted array to produce data. In certain instances, the data may be analyzed to determine the copy number of a genomic region in the sample. Also provided are arrays and kits useful to practice the method.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods of Sample Analysis

As noted above, a method of sample analysis is provided. In general terms, the method includes digesting the genomic DNA (e.g., mammalian DNA) of a sample with a Type IIB restriction enzyme to produce Type IIB fragments which are then directly labeled (i.e., labeled without any amplification prior to labeling) and hybridized with an array.

In certain cases, the labeling step uses a terminal dideoxytransferase to add a single labeled nucleotide to each strand of the Type IIB fragments, which provides a uniformly labeled population of labeled Type IIB fragments, independent of the sequences of the Type IIB fragments. Also, because there is a single label per labeled Type IIB fragment (once denatured), the magnitude of the signal produced by each feature of the hybridized array should directly correlate with the absolute copy number of a region of the genome.

In certain cases, the instant methods may be performed in the absence of a control hybridization using, e.g., a different genomic sample (one containing a region of known Type IIB fragment copy number) to which the results may be compared or normalized. Thus, in certain embodiments, the methods may be done using a “single channel,” i.e., using one type of fluorescent label, rather then using two channels that require the use of distinguishably labeled nucleic acids.

In other embodiments, a Type IIB fragment representative of a known region of the genome can be used as an external reference, and the fluorescence measurements compared or normalized. By “normalization” is meant that data corresponding to the two populations of Type IIB fragments are globally normalized to each other, and/or normalized to data obtained from controls (e.g., internal controls produce data that are predicted to be equal in value in all of the data groups). Normalization generally involves multiplying each numerical value for one data group by a value that allows the direct comparison of those amounts to amounts in a second data group. Several normalization strategies have been described (Quackenbush et al., Nat. Genet. 2002; 32 Suppl: 496-501; Bilban et al., Curr Issues Mol. Biol. 2002; 4:57-64; Finkelstein et al., Plant Mol. Biol. 2002; 48(1-2):119-31; and Hegde et al., Biotechniques 2000; 29:548-554). Specific examples of normalization suitable for use in the subject methods include linear normalization methods, non-linear normalization methods, e.g., using Lowess local regression to paired data as a function of signal intensity, signal-dependent non-linear normalization, qspline normalization and spatial normalization, as described in Workman et al., (Genome Biol. 2002; 3: 1-16). In certain embodiments, the numerical value associated with a feature signal is converted into a log number, either before or after normalization occurs. Data may be normalized to data obtained using a support-bound polynucleotide probe for a polynucleotide of known concentration, for example.

In particular embodiments, the subject methods may include labeling Type IIB fragments with a single labeled nucleotide to make single nucleotide extended Type IIB fragments (i.e., Type IIB fragments that are extended by a single labeled nucleotide), which are then contacted with a subject array under suitable hybridization conditions (e.g., the combination of a hybridization buffer, temperature and time) that provide binding equilibrium. In particular embodiments, because the hybridization has reached equilibrium, the amount of binding of Type IIB fragments to each oligonucleotide of a set of oligonucleotides is directly proportional to the ratio of the binding constants of oligonucleotides to Type IIB fragments. As an example, a digestion of a sample of 10 μg of genomic DNA with a Type IIB restriction enzyme should yield about 2 attomoles of each unique Type IIB fragment.

Methods for isolating genomic DNA from mammalian cells are well known, and exemplary methods are described in Sambrook, supra. Isolated genomic DNA may be digested with a Type IIB restriction enzyme under the manufacturers conditions. For example, BcgI requires incubation at 37° C. in a buffer of 50 mM Tris-HCl, 100 mM NaCl, 10 mM MgCl₂ and 1 mM DTT. One of skill in the art will appreciate an effective number of units of Type IIB restriction enzyme to use based on the manufacturer's instructions.

Type IIB fragments of interest may be purified away from genomic DNA fragments by gel purification or column chromatography. In certain cases, the Type IIB fragments may be purified by electrophoresis on an 8% polyacrylamide gel, the band excised and the Type IIB fragments purified by electroelution, crush and soak or other methods of DNA purification well known to the skilled artisan and can be found in Sambrook et al., supra.

The Type IIB fragment is directly labeled to make a population of labeled Type IIB fragments. In general, a sample may be labeled using methods that are well known in the art (e.g., using a DNA ligase, terminal transferase, polymerase, etc.; see, e.g., Ausubel, et al., Short Protocols in Molecular Biology, 3rd ed., Wiley & Sons 1995 and Sambrook et al., supra), and, accordingly, such methods do not need to be described here in great detail. In particular embodiments, the sample is may be labeled with single fluorescently labeled nucleotide, which will be described in greater detail below.

Fluorescent dyes of particular interest include: xanthene dyes, e.g. fluorescein and rhodamine dyes, such as fluorescein isothiocyanate (FITC), 6-carboxyfluorescein (commonly known by the abbreviations FAM and F), 6-carboxy-2′,4′,7′,4,7-hexachlorofluorescein (HEX), 6-carboxy-4′,5′-dichloro-2′,7′-dimethoxyfluorescein (JOE or J), N,N,N′,N′-tetramethyl-6-carboxyrhodamine (TAMRA or T), 6-carboxy-X-rhodamine (ROX or R), 5-carboxyrhodamine-6G (R6G⁵ or G⁵), 6-carboxyrhodamine-6G (R6G⁶ or G⁶), and rhodamine 110; cyanine dyes, e.g. Cy3, Cy5 and Cy7 dyes; Alexa dyes, e.g. Alexa-fluor-555; coumarins, e.g. umbelliferone; benzimide dyes, e.g. Hoechst 33258; phenanthridine dyes, e.g. Texas Red; ethidium dyes; acridine dyes; carbazole dyes; phenoxazine dyes; porphyrin dyes; polymethine dyes, e.g. cyanine dyes such as Cy3, Cy5, etc; BODIPY dyes and quinoline dyes. Specific fluorophores of interest that are commonly used in subject applications include: Pyrene, Coumarin, Diethylaminocoumarin, FAM, Fluorescein Chlorotriazinyl, Fluorescein, R110, Eosin, JOE, R6G, Tetramethylrhodamine, TAMRA, Lissamine, ROX, Napthofluorescein, Texas Red, Napthofluorescein, Cy3, and Cy5, etc.

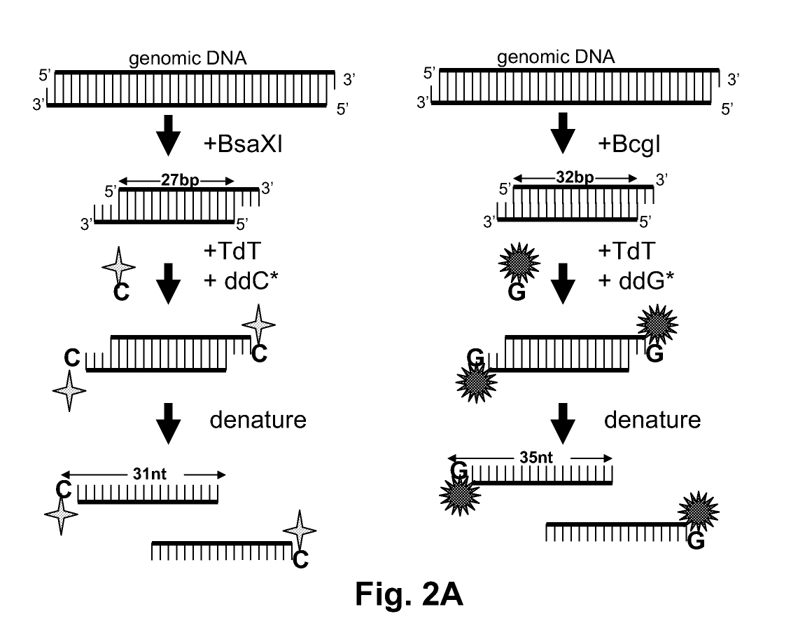

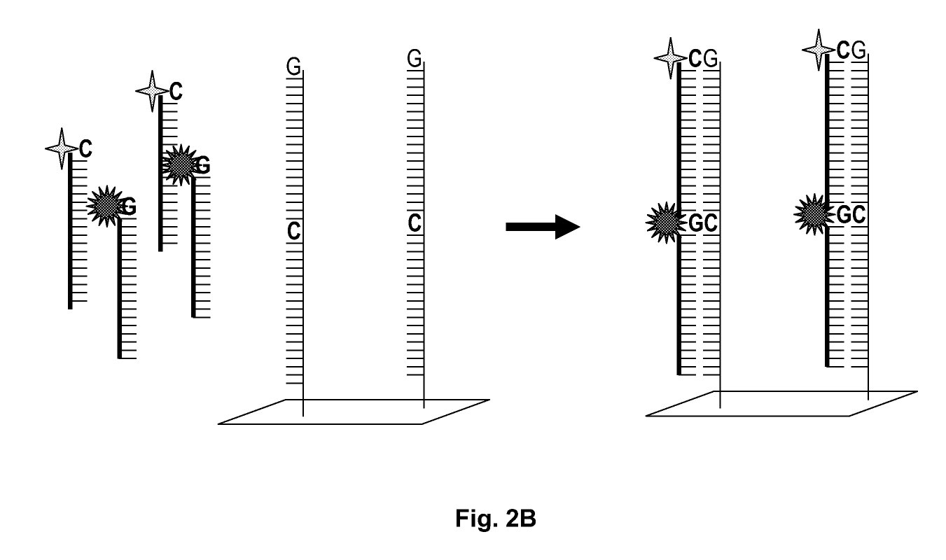

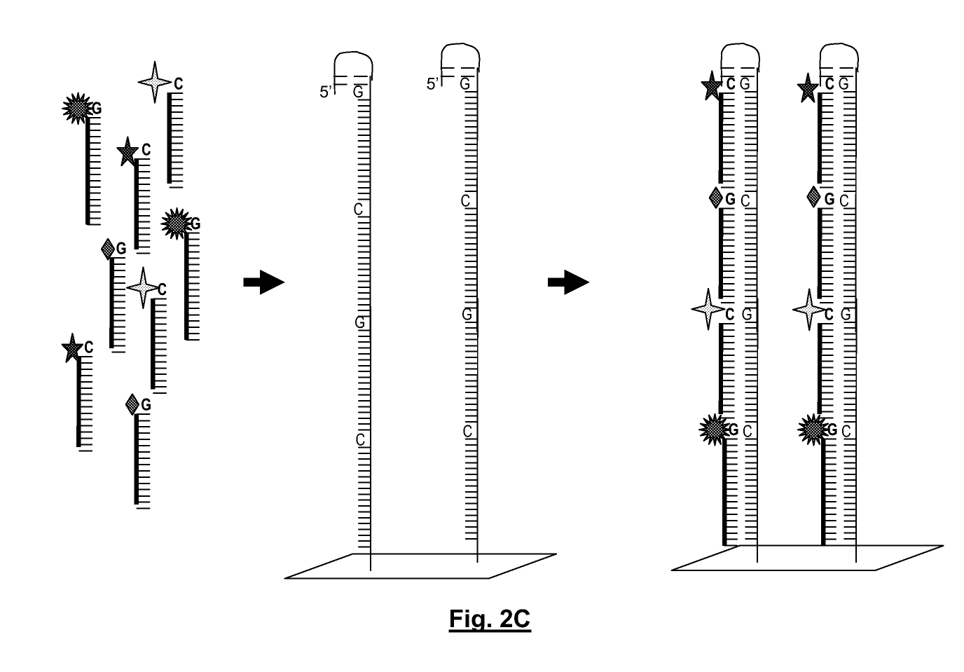

In practicing the subject methods, the Type IIB fragments may be labeled to provide at least two different populations of labeled Type IIB fragments that are to be compared, for example, when two different Type IIB restriction enzymes are used. The differing populations of Type IIB fragments may be labeled with the same label or different labels, depending on the actual assay protocol employed. For example, where each Type IIB fragment population is to be contacted with different but identical arrays, each nucleic acid population may be labeled with the same label. Alternatively, where both Type IIB fragment populations are to be simultaneously contacted with a single array of surface-bound nucleic acids, i.e., co-hybridized, to the same array of immobilized oligonucleotides, the Type IIB fragments may be distinguishably labeled with respect to each other (FIG. 2A-2C).

The Type IIB fragments are sometimes labeled using “distinguishable” labels in that the labels that can be independently detected and measured, even when the labels are mixed. In other words, the amounts of label present (e.g., the amount of fluorescence) for each of the labels are separately determinable, even when the labels are co-located (e.g., in the same tube or in the same duplex molecule or in the same feature of an array). Suitable distinguishable fluorescent label pairs useful in the subject methods include Cy-3 and Cy-5 (Amersham Inc., Piscataway, N.J.), Quasar 570 and Quasar 670 (Biosearch Technology, Novato Calif.), Alexafluor555 and Alexafluor647 (Molecular Probes, Eugene, Oreg.), BODIPY V-1002 and BODIPY V1005 (Molecular Probes, Eugene, Oreg.), POPO-3 and TOTO-3 (Molecular Probes, Eugene, Oreg.), fluorescein and Texas red (Dupont, Boston Mass.) and POPRO3 and TOPRO3 (Molecular Probes, Eugene, Oreg.). Further suitable distinguishable detectable labels may be described in Kricka et al. (Ann Clin Biochem. 39:114-29, 2002).

Terminal dideoxytransferases may be obtained from any of a variety of manufacturers, including New England Biolabs Ipswich, Mass. and Invitrogen (Carlsbad, Calif.), and may be used according to the recommended protocols supplied therewith. In general terms, the labeled Type IIB fragments may be contacted with a terminal dideoxytransferase in the presence of a labeled dideoxynucleotide (e.g., labeled ddA, labeled ddT, labeled ddG or labeled ddC, or any combination thereof), and a single labeled nucleotide is added to the Type II fragments.

In certain cases, the subject methods may comprise the following major steps: (1) provision of an array containing surface-bound oligonucleotides; (2) hybridization of a population of labeled Type IIB fragments to the surface-bound oligonucleotides, e.g., under high stringency conditions; (3) post-hybridization washes to remove nucleic acids not bound in the hybridization; and (4) detection of the hybridized Type IIB fragments to the oligonucleotides. The reagents used in each of these steps and their conditions for use varies depending on the particular application.

Standard hybridization techniques (using high stringency hybridization conditions) are used to probe a subject array. Suitable methods are described in many references (e.g., Kallioniemi et al., Science 1992; 258:818-821 and WO 93/18186). Several guides to general techniques are available, e.g., Tijssen, Hybridization with Nucleic Acid Probes, Parts I and II (Elsevier, Amsterdam 1993). For example, stringent hybridization conditions may occur in a buffer containing 50% formamide, 5×SSC and 1% SDS at 42° C., or in a buffer containing 5×SSC and 1% SDS at 65° C., both with a wash of 0.2×SSC and 0.1% SDS at 65° C. The above hybridization step may include agitation of the immobilized targets and the sample of labeled nucleic acids, where the agitation may be accomplished using any convenient protocol, e.g., shaking, rotating, spinning, and the like.

In one embodiment of the instant methods, the labeled Type IIB fragments and the array hybridize for a period of time that provides for equilibrium binding. In certain cases, because the Type IIB fragments are of a short sequence, equilibrium may be reached in about 20 hours. Although this time period may vary depending on the other hybridization conditions and the length and Tₘ of the oligonucleotides used, such a period may be at least 20 hours, e.g., at least 30 hours, at least 40 hours, at least 50 hours, up to about 100 or more hours.

Following hybridization and washing, as described above, the hybridization of the labeled Type IIB fragments to the array is then detected using standard techniques so that the surface of the array is read. Reading of the resultant hybridized array may be accomplished by illuminating the array and reading the location and intensity of resulting fluorescence at each feature of the array to detect any binding complexes on the surface of the array. For example, a scanner may be used for this purpose that is similar to the AGILENT MICROARRAY SCANNER available from Agilent Technologies, Palo Alto, Calif. Other suitable devices and methods are described in U.S. patent application Ser. No. 09/846,125 “Reading Multi-Featured Arrays” by Dorsel et al.; and U.S. Pat. No. 6,406,849, which references are herein incorporated by reference. However, arrays may be read by any other method or apparatus than the foregoing, with other reading methods including other optical techniques (for example, detecting chemiluminescent or electroluminescent labels), or electrical techniques (where each feature is provided with an electrode to detect hybridization at that feature in a manner disclosed in U.S. Pat. No. 6,221,583 and elsewhere).

Results from the reading or evaluating may be raw results (such as fluorescence intensity readings for each feature in one or more color channels) or may be processed results (such as those obtained by subtracting a background measurement, or by rejecting a reading for a feature which is below a predetermined threshold, normalizing the results, and/or forming conclusions based on the pattern read from the array (such as whether or not a particular target sequence may have been present in the sample, or whether or not a pattern indicates a particular condition of an organism from which the sample came).

### Type IIB Fragment-Detecting Oligonucleotides

A Type IIB fragment-detecting oligonucleotide contains a region that is complementary to and base-pairs with a Type IIB fragment. The region generally contains a contiguous nucleotide sequence that is complementary to the nucleotide sequence of a corresponding Type IIB fragment and is of a length that is sufficient to provide specific binding between the oligonucleotide and the corresponding Type IIB fragment. Because Type IIB fragments are generally in the range of 27-33 base pairs in length, the binding region is generally of that size. The Type IIB fragment-detecting oligonucleotide, if it is attached to a solid support, may be attached via its 3′ end or its 5′ end. If the Type IIB fragment-detecting oligonucleotide is attached to a solid support via its 3′ end, the nucleotide at the 5′ end of the first region of the oligonucleotide may base pair with the 3′ terminal nucleotide of the Type IIB fragment to be detected. Conversely, if the oligonucleotide is attached to a solid support via its 5′ end, the nucleotide at the 3′ end of the first region of the oligonucleotide may base pairs with the 5′ terminal nucleotide of a Type IIB fragment to be detected. A Type IIB fragment-detecting oligonucleotide need not be complementary to the entire length of a corresponding Type IIB fragment to be detected, and a Type IIB fragment to be detected need not be complementary to the entire length of an oligonucleotide.

The binding region of a Type IIB fragment-detecting oligonucleotide therefore corresponds to, i.e., hybridizes to and may be used to detect, a particular Type IIB fragment. In many embodiments, the binding region is specific for a particular Type IIB fragment, in that it can detect a specific Type IIB fragment, even in the presence of other Type IIB fragments. In other words, embodied oligonucleotides contain a binding region that is specifically complementary to a particular Type IIB fragment.

In particular embodiments and as noted above, a Type IIB fragment-detecting oligonucleotide may be designed to be complementary to the entirety of a single nucleotide extended Type IIB fragment, i.e., a Type IIB fragment extended by a single nucleotide using a terminal transferase. Such an oligonucleotide contains a Type IIB fragment complementary region and, immediately adjacent to that region, a nucleotide that base pairs with the single nucleotide added to the Type IIB fragment.

In certain cases, it may be desirable to design the Type IIB fragment-detecting oligonucleotides to contain a binding region shorter than the entire sequence of the extended Type IIB fragment. For example, certain Type IIB extended fragments may have regions high in content of the nucleotides guanine and cytosine (“GC-rich”) and may have a higher Tₘ than other Type IIB extended fragments. In this case, Type IIB fragment-detecting oligonucleotides complementary to the GC-rich Type IIB extended fragments may be designed to hybridize to only a portion of the GC-rich Type IIB extended fragments, such that the duplex of a Type IIB fragment-detecting oligonucleotide with a GC-rich Type IIB extended fragment may have a Tₘ approximating the Tₘ of other (non-GC-rich) Type IIB extended fragments. For example, a Type IIB fragment-detecting oligonucleotide may be designed to hybridize only to 25 nucleotides (including the extended nucleotide) of a GC-rich, 35-nucleotide, extended Type IIB fragment, in order to create a duplex with a Tₘ equal to other (longer or shorter) duplexes between Type IIB fragment-detecting oligonucleotides and their target Type IIB fragments. Alternatively, certain Type IIB fragment-detecting oligonucleotides may be designed to contain duplex-destabilizing elements such as mismatches, to decrease the stability of the duplexes formed. In this fashion different Type IIB fragment-detecting oligonucleotides may be Tₘ-matched to detect Type IIB fragment sequences of different GC content.

In certain cases, the Type IIB fragment-detecting oligonucleotide may contain a Tₘ enhancement domain which increases the stability of the duplex formed, and may discriminate against hybridization of other sequences. This is provided, by example, by a hairpin structure that increases stability via “stacking” (as illustrated in FIG. 1). A hairpin structure may have a loop of at least 3 or 4 nucleotides, up to 10 or 20 nucleotides and a double-stranded stem in which complementary nucleotides bind to each other in an anti-parallel manner. Depending on which end of the oligonucleotide is attached to the solid support, the hairpin structure may be linked to the 3′ or 5′ end of the binding region. The hairpin structure may contain from approximately 5 to about 30 nucleotides, e.g., about 8-20 nucleotides. In a duplex formed between a Type IIB fragment-detecting oligonucleotide containing a hairpin region and a Type IIB fragment, the hairpin region allows the Type IIB fragment to bind more tightly, i.e., more stably. When a Type IIB fragment is labeled, an additional nucleotide may be added, creating a “single nucleotide extended Type IIB fragment.” For example, as shown in FIG. 1, a 32 base pair BcgI fragment contacted with terminal deoxytransferase (TdT) has a labeled dideoxy guanine (ddG) added to each 3′ end of the double stranded Type IIB fragment. When this single nucleotide extended Type IIB fragment is denatured and hybridized to an oligonucleotide containing a hairpin region, the terminal nucleotide (ddG) of the single nucleotide extended Type IIB fragment may occupy a position that is immediately opposite and able to base pair to a terminal nucleotide of the oligonucleotide (shown in FIG. 1 as a bolded “C” (cytosine)). In this embodiment, the duplex produced by binding of a single nucleotide extended Type IIB fragment to an oligonucleotide probe resembles a long hairpin structure containing a label in the stem of the hairpin (FIG. 1). Stacking and its effect on duplex stability are discussed in Liu et al., (Nanobiology 1999; 4: 257-262), Walter et al., (Proc. Natl. Acad. Sci. 1994 91:9218-9222) and Schneider et al., (J. Biomol. Struct. Dyn. 2000; 18:345-52).

The hairpin structure effectively increases the stability (i.e., increases the tightness of binding and increases the melting temperature (Tₘ) of a duplex containing a single nucleotide extended Type IIB fragment and an oligonucleotide, as compared to the stability of a duplex obtained using an oligonucleotide that does not contain the hairpin domain.

In addition to increasing the Tₘ of a duplex, the use of a hairpin structure in an oligonucleotide allows it to discriminate between different Type IIB fragments that are perfectly complementary to the probe. For example, as noted above, in some embodiments an oligonucleotide containing a hairpin region is designed to contain a nucleotide that is base paired with, a single nucleotide extended Type IIB fragment when it is hybridized with the oligonucleotide. This arrangement induces stacking, which, as explained above, increases the strength of binding between the nucleic acid probe and polynucleotide. If the terminal nucleotide of the single nucleotide extended Type IIB fragment does not lie immediately adjacent to the nucleotide at the end of the probe (for example, if the bound nucleic acid is longer or shorter than the target Type IIB fragment to be detected), then no stacking may occur. In other words, the hairpin structure provides for steric hindrance of Type IIB fragments that are not a target. Thus, only the single nucleotide extended Type IIB fragments will be bound to the oligonucleotides. Unlabeled, unextended Type IIB fragments will not stack. Furthermore, nucleic acids with additional sequence adjacent to the targeted Type IIB fragment sequence may not stack. Thus, stacking provides for results that may have reduced background and better signal intensity.

### Arrays

Certain embodiments of the methods described herein employ an array comprising a set of oligonucleotides for detecting a set of particular Type IIB fragments. Representations of the human genome have been sequenced (Venter et al., Science 2001; 291:1304-1351). With this information, oligonucleotides for array analysis of the genome can be designed. One means of designing such a set would be based on the use of Type IIB restriction enzymes. Type II B restriction enzymes recognize a certain sequence in DNA, and then cleave the DNA on either side of the recognition sequence. Digestion of a nucleic acid with a Type IIB restriction enzyme will result in the creation of double stranded Type IIB fragments with a Watson strand and a Crick strand. These short double stranded fragments may be from 27 to 33 base pairs and contain the Type IIB restriction enzyme recognition site (Roberts et al., Nucl. Acids Res. 2007; 35:269-270). For example, DNA digested with BcgI produces a double stranded 32 base pair Type IIB fragment with 2-base overhangs, containing the 6-base recognition sequence. Labeling with TdT will produce a double stranded Type IIB fragment with a single label at each 3′ end. Denaturation will separate the labeled single stranded Watson and Crick strands, and oligonucleotides can be designed to hybridize to each respective strand.

Although the recognition sequence will be the same in each Type IIB fragment, the rest of the sequence (28 bases in the case of BcgI) will vary, and in many cases the sequence of each fragment will occur only once in the human genome. Because BcgI has a recognition site occurring once site per 2048 bases of random sequence, a “digestion” of the entire human genomic sequence may be performed in silico and oligonucleotides can be designed to match the sequence of each of these fragments. Thus, each Type IIB fragment should be known prior to design of a set of Type IIB fragment-detecting oligonucleotides and such design is well within the skill of the skilled artisan. The Type IIB fragment-detecting oligonucleotides may be linked to a phenotype of a person suspected of having a variation in copy number, i.e., a disease or disorder, or may be unlinked to a phenotype.

In certain cases, it is possible to sample the genome multiple times using several different Type IIB restriction enzymes. For example, a genomic sample may be digested with BcgI in one digestion and then BsaXI in a separate digestion, creating Type IIB fragments of differing sequence (See FIG. 2A-2C). In this embodiment, single oligonucleotides may be designed allowing both differing Type IIB fragments to hybridize to the same oligonucleotide with exact sequence complementarity to each Type IIB fragment (see FIGS. 2B and 2C). In other words, the shorter BsaXI fragment would bind to its own respective hybridization region of the oligonucleotide, while the longer BcgI fragment would bind to its own region with no overlap between the two fragments. Alternatively, single oligonucleotides on the same array may be designed to hybridize to each of the different Type IIB fragments individually. In this embodiment, oligonucleotides specific for the shorter BsaXI fragment could be arranged on the same array as oligonucleotides for the longer BcgI fragment. The BsaXI and BcgI fragments could be labeled with the same detectable label or differing labels. Digestion of genomic DNA with multiple Type IIB enzymes provides for multiple sampling of the genome, which in turn, allows for greater clarity in determining the copy number of a region of the genome.

In certain cases the Type IIB fragment-detecting oligonucleotides of a subject array may be “Tₘ matched” in that they are designed to have a similar melting temperature (e.g., within 1 or 2° C. of a chosen Tₘ) under the hybridization conditions used. The Tₘ of an oligonucleotide may be calculated using conventional methods, e.g., in silico or experimentally. In certain embodiments, Type IIB fragment-detecting oligonucleotides may be designed to include mismatched bases or nucleotide analogs to modify the Tₘ. In other embodiments, the length of the region complementary to certain targeted Type IIB fragments may be reduced to reduce the Tₘ. For example, Type IIB fragments with a higher-than-average GC content may be targeted by Type IIB fragment-detecting oligonucleotides that do not hybridize to the entire length of the GC-rich Type IIB fragment, thus lowering the Tₘ of the duplex. In this fashion, an array may be constructed which detects a wide variety of sequences with Type IIB fragment-detecting oligonucleotides which are Tₘ matched. In general, because the Type IIB fragments are short sequences, their Tₘ is more predictable.

In certain embodiments, the Type IIB fragment-detecting oligonucleotides are “surface-bound Type IIB fragment-detecting oligonucleotides”, where such an oligonucleotide is a Type IIB fragment-detecting oligonucleotide that is bound, usually covalently but in certain embodiments non-covalently, to a surface of a solid substrate, i.e., a sheet, bead, or other structure, to form an array. In certain embodiments, surface-bound Type IIB fragment-detecting oligonucleotides may be immobilized on a surface of a planar support, e.g., as part of an array.

A “Type IIB fragment-detecting oligonucleotide feature” is a feature of an array, i.e., a spatially addressable area of an array, as described above, that contains a plurality of molecules of the same surface-bound Type IIB fragment-detecting oligonucleotide. Accordingly, a feature contains “surface-bound” oligonucleotides that are bound, usually covalently, to an area of an array. In most embodiments a single type of oligonucleotide is present in each Type IIB fragment-detecting oligonucleotide feature (i.e., all the oligonucleotides in the feature have the same sequence). However, in certain embodiments, the oligonucleotides in a feature may be a mixture of oligonucleotides with different sequence.

The subject arrays may contain a single set of Type IIB-detecting oligonucleotide features, e.g., a pair of features, one for each of a pair of Type IIB-detecting oligonucleotides, for detecting a single Type IIB fragment. However, in many embodiments, the subject arrays may contain more than one such feature, and those features may correspond to (i.e., may be used to detect) a plurality of Type IIB fragments of a genome. Accordingly, the subject arrays may contain a plurality of features (i.e., 2 or more, about 5 or more, about 10 or more, about 15 or more, about 20 or more, about 30 or more, about 50 or more, about 100 or more, about 200 or more, about 500 or more, about 1000 or more, usually up to about 10,000 or about 20,000 or more features, etc.), each containing a different Type IIB fragment-detecting oligonucleotide. In certain embodiments, therefore, the subject arrays contain a plurality of subject oligonucleotide features that correspond to a plurality of Type IIB fragments of a genome. In particular embodiments, therefore, the subject arrays may contain Type IIB fragment-detecting oligonucleotide features for, i.e., corresponding to, all of the predicted Type IIB fragments of a particular genome. The subject arrays may contain for example at least up to at least 45,000 different Type IIB fragment-detecting features.

In general, arrays suitable for use in performing the subject methods contain a plurality (i.e., at least about 100, at least about 500, at least about 1000, at least about 2000, at least about 5000, at least about 10,000, at least about 20,000, usually up to about 100,000 or more) of addressable features containing oligonucleotides that are linked to a usually planar solid support. Features on a subject array usually contain oligonucleotides that hybridize to, i.e., bind to, Type IIB fragments from a sample. Accordingly, Type IIB detection arrays typically involve an array containing a plurality of different sets of Type IIB-detecting oligonucleotides that are addressably arrayed. In particular embodiments, Type IIB fragments of interest are represented by at least 2, about 5, or about 10 or more, e.g., up to about 20 sets of Type IIB fragment-detecting oligonucleotide features. Such an array may contain duplicate oligonucleotides, or different oligonucleotides for the same Type IIB fragment.

In general, methods for the preparation of oligonucleotide arrays are well known in the art (see, e.g., Harrington et al, Curr. Opin. Microbiol. 2000; 3:285-91, and Lipshutz et al., Nat. Genet. 1999; 21:20-4) and need not be described in any great detail. The subject oligonucleotide arrays can be fabricated using any means, including drop deposition from pulse jets or from fluid-filled tips, etc, or using photolithographic means. Either polynucleotide precursor units (such as nucleotide monomers), in the case of in situ fabrication, or previously synthesized polynucleotides can be deposited. In some embodiments, the arrays may be constructed to include oligonucleotide analogs such as nucleotide analogs such as 2,6-aminopurines. Such methods are described in detail in, for example U.S. Pat. Nos. 6,242,266, 6,232,072, 6,180,351, 6,171,797, 6,323,043, and U.S. Patent Application US20040086880 A1, etc., the disclosures of which are herein incorporated by reference.

### Kits

Also contemplated by the subject invention are kits for practicing the above described subject methods. The subject kits contain at least a subject oligonucleotide. The oligonucleotide may be bound to the surface of a solid support and may be present in an array. The kit may also contain reagents for isolating genomic DNA from a cell, reagents for digesting the genomic DNA, reagents for purifying Type IIB fragments, reagents for directly labeling Type IIB fragments, reagents for hybridizing labeled Type IIB fragments to an array, a control Type IIB fragment etc. The various components of the kit may be present in separate containers or certain compatible components may be precombined into a single container, as desired.

In addition to above-mentioned components, the subject kits may further include instructions for using the components of the kit to practice the subject methods, i.e., to instructions for sample analysis. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g., via the internet, are provided. An example of this embodiment is a kit that includes a web address where the instructions can be viewed and/or from which the instructions can be downloaded. As with the instructions, this means for obtaining the instructions is recorded on a suitable substrate.

### Utility

The above described method is useful for the analysis of genomic DNA, for example. The subject methods may be employed in a variety of diagnostic, drug discovery, and research applications that include, but are not limited to, diagnosis or monitoring of a disease or condition where there is modulation of gene expression due to variation in copy number of a region of the genome. In a certain aspect, the modulation may be downregulation of gene expression; in other embodiments it includes upregulation of gene expression. The subject methods may also be employed in the discovery of drug targets, where an agonist or antagonist would be useful in alleviating the effects caused by variation in copy number of a region of the genome; drug screening, where the effects of a drug are monitored by assessing modulation of gene expression due to variation in copy number of a region of the genome; determining drug susceptibility, where drug susceptibility is associated with a particular profile of copy number variation in the genome; and basic research, where is it desirable to identify the presence of copy variation in the genome.

In certain embodiments, copy number variations in the genome may be obtained using the above methods, and compared. In these embodiments, the results obtained from the above-described methods can be compared to an internal reference or can be normalized to a control and compared. This may be done by comparing ratios, or by any other means.

The genomic DNA sample may consist of an “experimental” sample, i.e., a sample of interest, and a “control” sample to which the experimental sample may be compared. In many embodiments, the genomic DNA sample is derived from a cell of interest, e.g., an abnormal cell, or a normal cell suspected of having a variation in copy number. Exemplary cell types include, for example, cells isolated from a tissue biopsy (e.g., from a tissue having a disease such as colon, breast, prostate, lung, skin cancer, or infected with a pathogen etc.) cells grown in tissue culture that are immortal, infected with a pathogen, or treated (e.g., with environmental or chemical agents such as peptides, hormones, altered temperature, growth condition, physical stress, cellular transformation, etc.) cells from a geriatric mammal, or a mammal exposed to a condition. In another embodiment of the invention, the genomic DNA is taken from cells susceptible to infection by a pathogen such as a virus, e.g., human immunodeficiency virus (HIV), etc. It is appreciated that if a reference control is desired, then normal cells may be taken from the area surrounding the biopsy, non-immortalized cells taken from the same source, uninfected cells of the same type or cells that have not been exposed to environmental or chemical agents.

The described methods may utilize cells from yeast, plants and animals, such as fish, birds, reptiles, amphibians and mammals may be used in the subject methods. In certain embodiments, mammalian cells, i.e., cells from mice, rabbits, primates, or humans, or cultured derivatives thereof, may be used.

Accordingly, among other things, the instant methods may be used to link the variation in copy number in the genome to certain physiological events.

### Example 1

As shown in FIG. 1, genomic DNA will be digested with a Type IIB restriction enzyme such as BcgI. This will produce a 32 base pair fragment. Alternatively, multiple digestions will be set up, such as shown in FIG. 2, where BsaXI and BcgI will be set up in different reactions, and produce different sized fragments. These fragments will be gel purified away from the rest of the genomic DNA that should not contain a BcgI site, if the BcgI reaction will progress to completion. In this example, a BcgI digest will leave a 3′ two (2) nucleotide overhang, which will allow end labeling of the 3′ ends by terminal deoxytransferase (TdT). If labeled dideoxynucleotides are used, a single label will be added to each strand of the Type IIB fragment. This is represented by the labeled dideoxy guanine (ddG) in FIG. 1. The Type IIB fragment will be denatured, and hybridized under stringent conditions to an oligonucleotide that will be bound to the surface of an array. Due to the 2 nucleotide overhang and the single added nucleotide, the surface-bound oligonucleotides may form 3 additional base pairs with each strand of the Type IIB fragment, which are not present in the original Type IIB fragment. For best results, the oligonucleotide will contain a hairpin structure and a nucleotide that will be complementary to the nucleotide added to the Type IIB fragment by the TdT (for example, see SEQ ID NO:6). The oligonucleotide will be designed to detect either the Watson or the Crick strands of the Type IIB fragment. Because the TdT adds only a single label, and because the hairpin containing oligonucleotide renders the array able to reliably detect Type IIB fragments at the sub-attomolar levels, the copy number of a region of the genome will be directly determined by measuring the fluorescence bound to the array.

An example of the cleavage sequence of the TypeIIB enzyme BcgI is shown in SEQ ID NO:1 and SEQ ID NO:2. The letter N denotes any base and the recognition sequence is in bold type. When SEQ ID NO:1 (34 nucleotides) hybridizes with SEQ ID NO:2 (also 34 nucleotides), it forms a duplex with 32 base pairs and 3′ overhangs of 2 nucleotides.

A predicted cleavage sequence for BcgI from the human gene, ErbB2 (chr17:35,126,103-35,126,138) is shown in SEQ ID NO:3 and SEQ ID NO:4. The recognition sequence is in bold type. SEQ ID NO:3 denotes the fragment created from the forward strand, and SEQ ID NO:4 denotes the fragment created from the reverse strand.

An example of a single-nucleotide extended Type IIB fragment created from SEQ ID NO:3 is shown in SEQ ID NO:5. The underlined base is added in the extension.

An example of Type IIB fragment-detecting oligonucleotide with a hairpin-forming sequence is shown in SEQ ID NO:6. The hairpin-forming sequence is shown in bold and a base complementary to the single base extension in SEQ ID NO:5 is underlined. An oligonucleotide containing this example sequence could be tethered to a surface via the 3′ end, and could thus be used to measure the copy number of the ErbB2 locus.

SEQ ID NO: 1

5′ NNNNNNNNNNCGANNNNNNTGCNNNNNNNNNNNN 3′

SEQ ID NO: 2

5′ NNNNNNNNNNGCANNNNNNTCGNNNNNNNNNNNN 3′

SEQ ID NO: 3

5′ GCTGTGCGCCCGAGGGCACTGCTGGGGTCCAGGG 3′

SEQ ID NO: 4

5′ CTGGACCCCAGCAGTGCCCTCGGGCGCACAGCTG 3′

SEQ ID NO: 5

5′ GCTGTGCGCCCGAGGGCACTGCTGGGGTCCAGGGC 3′

SEQ ID NO: 6

5′ GCGCGCGCTTTTGCGCGCGCGCCCTGGACCCCAGCAGTGCCCTCGGG
CGCACAGC 3′

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of sample analysis, comprising:
a) contacting a sample comprising genomic DNA with a Type IIB restriction enzyme to produce Type IIB fragments;
b) directly labeling said Type IIB fragments with a fluorescent label to produce labeled fragments;
c) contacting said labeled fragments with an array under suitable hybridization conditions to produce a contacted array;
d) reading said contacted array to provide data.

2. The method of claim 1, wherein said directly labeling comprises adding a single fluorescently labeled dideoxynucleotide to said Type IIB fragments using a terminal transferase to produce single nucleotide extended Type IIB fragments.

3. The method of claim 2, wherein said array comprises oligonucleotide probes that are complementary to said terminally extended Type IIB fragments, including said single nucleotide.

4. The method of claim 3, wherein said oligonucleotide probes comprise a hairpin comprising a terminal nucleotide that is adjacent to said single nucleotide, when said single nucleotide extended Type IIB fragments are hybridized to said oligonucleotide probe.

5. The method of claim 1, wherein said Type IIB fragments are not amplified prior to said directly labeling.

6. The method of claim 1, further comprising: e) analyzing said data to provide an absolute copy number of a genomic locus.

7. The method of claim 6, wherein said data is not compared to data obtained using a reference sample.

8. The method of claim 1, wherein said contacting step a) produces Type IIB fragments, and said method comprises size separating said Type IIB fragments from the remainder of said genome prior to said directly labeling step b).

9. The method of claim 8, wherein said size separating is done by gel electrophoresis or column chromatography.

10. The method of claim 1, wherein said genomic DNA is suspected of having a copy number abnormality.

11. The method of claim 1, wherein said sample comprises 1-20 μg of mammalian genomic DNA.

12. The method of claim 1, wherein said contacting step a) employs more than one Type IIB restriction enzyme.

13. The method of claim 1, wherein contacting step c) is done under conditions that provide for binding equilibrium.

14. An oligonucleotide array comprising a plurality of features each comprising a surface-tethered oligonucleotide that has a region complementary to a part of the sequence of a single nucleotide extended Type IIB fragment, said part including the extended nucleotide.

15. The oligonucleotide array of claim 14, wherein said features comprise surface-tethered oligonucleotides having a region complementary to the entire sequence of a single nucleotide extended Type IIB fragment.

16. The oligonucleotide array of claim 14, wherein said features comprise surface-tethered oligonucleotides that are Tₘ matched.

17. The oligonucleotide array of claim 14, wherein said surface-tethered oligonucleotide further comprises a hairpin structure that terminates adjacent to the extended nucleotide of a single nucleotide extended Type IIB fragment.

18. The oligonucleotide array of claim 17, wherein said hairpin structure provides for stacking of the Type IIB fragment, when said Type IIB fragment is hybridized to said surface-tethered oligonucleotide.

19. The oligonucleotide array of claim 14, wherein said surface-tethered oligonucleotide is in the range of 27 to 100 nucleotides in length.

20. A kit for performing an array analysis on a sample of genomic DNA comprising:
a) an oligonucleotide array comprising surface tethered oligonucleotides that are complementary to Type IIB restriction enzyme fragments;
b) a Type IIB restriction enzyme;
c) reagents for directly labeling said Type IIB fragments by adding a single fluorescent nucleotide to a terminus to produce labeled fragments; and
e) reagents for hybridizing said of the labeled fragments to said array.

21. The kit of claim 19, wherein said reagents for directly labeling comprise a terminal transferase.
